(19) United States
(12) Patent Application Publication
(10) Pub. No.: US 2026/0292029 A1
(43) Pub. Date: Sep. 24, 2026

(54) ASSOCIATING VIRTUAL DEVICES IN VIRTUAL ENVIRONMENTS WITH USER SUBSCRIPTIONS IN A WIRELESS COMMUNICATIONS NETWORK

(71) Applicant: Lenovo (Singapore) Pte. Limited, Singapore (SG)

(72) Inventors: Dimitrios Karampatsis, Ruislip (GB); Emmanouil Pateromichelakis, Viersen (DE)

(73) Assignee: Lenovo (Singapore) Pte. Limited, Singapore (SG)

(21) Appl. No.: 18/998,039

(22) PCT Filed: Sep. 8, 2022
(86) PCT No.: PCT/EP2022/074935

§ 371 Date: Jan. 23, 2025

(30) Foreign Application Priority Data
Jul. 27, 2022 (GR) 20220100608

(51) Int. Cl. H04L 67/131; H04L 67/306; H04W 12/06

(52) U.S. Cl. CPC H04L 67/131; H04L 67/306; H04W 12/06

(57) ABSTRACT

There is provided a network entity. The network entity comprises a receiver arranged to receive a request from a first network entity and/or a first user equipment to associate a virtual device with a user subscription of a mobile core network. The network entity further comprises a processor arranged to generate credentials for the virtual device for use in establishing media sessions using the mobile core network. The network entity further comprises a transmitter arranged to send the credentials to the first network entity and/or the first user equipment.

### FIELD

The subject matter disclosed herein relates generally to the field of implementing the association of virtual devices in virtual environments with user subscriptions in a wireless communication network. This document defines a network entity and a method in a network entity.

### BACKGROUND

Virtual Reality (VR), Augmented Reality (AR) and Extended Reality (XR) are types of virtual experience services whereby users of electronic devices can interact with each other.

The metaverse is an open, shared, and persistent virtual world that offers access to the three dimensional (3D) virtual spaces, solutions, and environments created by users. The metaverse is a digital reality that combines aspects of social media, online gaming, AR, VR, and cryptocurrencies to allow users to interact virtually. As the metaverse grows, it will create online spaces where user interactions are more multidimensional than current technology supports. Instead of just viewing digital content, users in the metaverse will be able to immerse themselves in a space where the digital and physical worlds converge.

In the metaverse, everything the user creates and owns is their asset, whether it is a piece of virtual real estate or an artifact. The metaverse confers privileges of complete ownership on users. Moreover, the persistency factor is very important since even if a user exits the metaverse, the digital avatar would still be in the metaverse. It would run normally with other users engaging and interacting with the metaverse.

An avatar, a digital object, a virtual device, an object in the metaverse, and a digital twin, are all different representations of the objects/devices instantiated/deployed in a virtual environment. By some definitions, avatars are our digital representatives in a virtual environment. For example, a metaverse avatar of a user is essentially a manifestation of the user and/or their user equipment (UE) within the metaverse. The avatar can look exactly like the user or device appears in the real world, or can be augmented. As such, an avatar UE can be considered to be a digital representation of the user's device virtualized in the metaverse. The user's device may be a mobile phone, a cellular telephone, smart glasses, and/or a smart watch with which a user/users can interact. The provision of such virtual devices offers greater enrichment for users of virtual environments such as the metaverse.

Therefore, there is a need for the provision of localized metaverse services in a wireless communication network.

### SUMMARY

A virtual experience service may be delivered via a wireless communication network. In addition to the real objects which may host a device for the wireless communication network, their corresponding virtual objects are also capable of interacting with each other and to interact with physical objects via the wireless communication network. To provide a more immersive virtual experience, facilitating the communication of users within a virtual environment is important. Specifically, there is a requirement for a mechanism by which a user of a virtual device in a virtual environment can associate that virtual device with their user subscription of a wireless communication network. Consequently, the voice/media capabilities offered by a mobile core network operator (for example IP multimedia subsystems (IMS)) can be utilized to facilitate communications.

Disclosed herein are procedures for associating virtual devices in virtual environments with user subscriptions of a wireless communication network. Said procedures may be implemented by network entities and methods in network entities, in particular such entities within a mobile core network.

There is provided a network entity comprising a receiver arranged to receive a request from a first network entity and/or a first user equipment to associate a virtual device with a user subscription of a mobile core network. The network entity further comprising a processor arranged to generate credentials for the virtual device for use in establishing media sessions using the mobile core network. The network entity further comprising a transmitter arranged to send the credentials to the first network entity and/or the first user equipment.

There is further provided a method in a network entity. The method comprising receiving a request from a first network entity and/or a first user equipment to associate a virtual device with a user subscription of a mobile core network. The method further comprising generating credentials for the virtual device for use in establishing media sessions using the mobile core network. The method further comprising sending the credentials to the first network entity and/or the first user equipment.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for associating virtual devices in virtual environments with user subscriptions in a wireless communications network will now be described, by way of example only, with reference to the accompanying drawings, in which:

FIG. 1 illustrates an embodiment of a wireless communication system for discovery of devices in a virtual experience service in a wireless communication network;

FIG. 2 illustrates an embodiment of a user equipment apparatus that may be used for implementing the methods or aspects of methods described herein;

FIG. 3 illustrates an embodiment of a network node or function that maybe be used for implementing the methods or aspects of methods described herein;

FIG. 4 illustrates an embodiment of a multi-modal feedback service implemented in a wireless communication network;

FIG. 5 illustrates the communication of users using virtual devices owned in a virtual environment;

FIG. 6 illustrates an embodiment of a method in a network entity of a wireless communication network;

FIG. 7 illustrates an embodiment of a system implementing the methods described herein;

FIG. 8 illustrates a procedure for establishing media communication between virtual devices in a metaverse environment; and

FIG. 9 illustrates a further procedure for establishing media communication using virtual devices in a metaverse environment.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

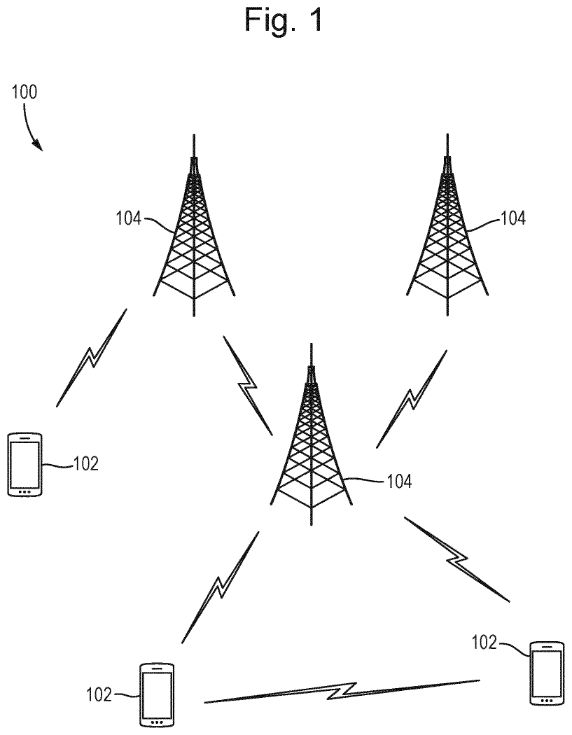

FIG. 1 depicts an embodiment of a wireless communication system 100 for associating virtual devices in a virtual environment with user subscriptions in a wireless communication network. The user subscriptions being user subscriptions of a mobile core network such as a 3GPP subscription. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

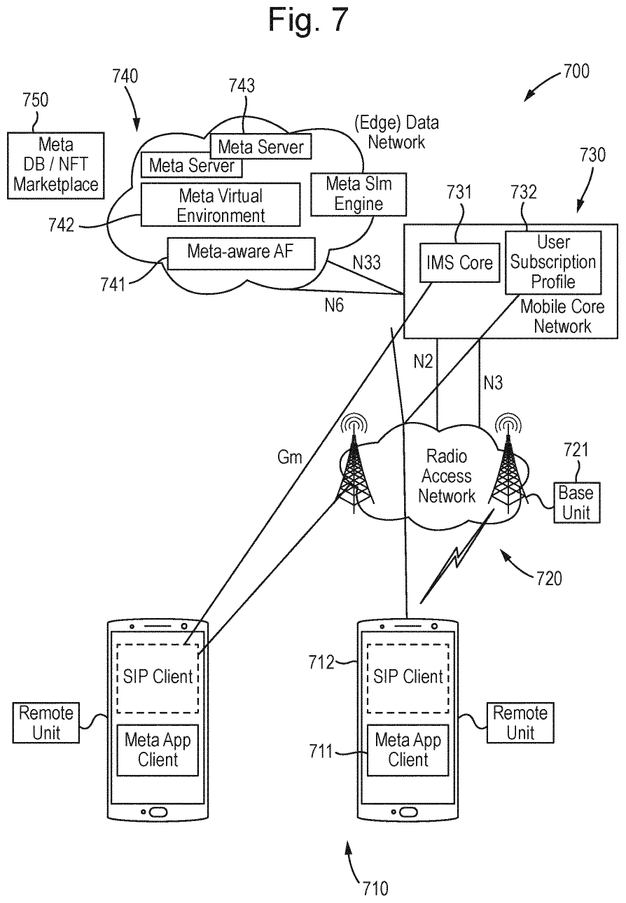

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. The remote units 102 may comprise XR enabled devices 710, 810, 910, indicated in FIGS. 7-9 respectively. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 may be base stations 721 shown in FIG. 7 or more generally may form part of a mobile core network 730, 820, 920, depicted in FIGS. 7-9 respectively. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

A wireless communication system can be adapted to more efficiently suited use cases and requirements for localized virtual experience services. A localized service may refer to a cell area; a tracking area; an edge service area; a private network area (for instance in a factory); or a local geographical area (for instance a stadium). Some examples of use cases are discussed below.

Since the industrial age, engineering design has become an extremely demanding activity. Collaborative and concurrent engineering occur as a concept and methodology at the end of the last century and was defined as a systematic approach to integrated and co-design of products and their related processes. The diversity and complexity of actual products, requires collaboration of engineers from different geographic locations to share the ideas and solutions with customers and to evaluate product development. VR and AR technologies have found their way into critical applications in industrial sectors such as aerospace engineering, automotive engineering, medical engineering, and in the field of education and entertainment. The range of technologies include Cave Automatic Virtual Environment (better known by the recursive acronym CAVE) environments, reality theatres, power walls, holographic workbenches, individual immersive systems, head mounted displays, tactile sensing interfaces, haptic feedback devices, multi-sensational devices, speech interfaces, and mixed reality systems.

Mobile virtual environment based multi-modal feedback service describes a case of multi-physical entities or their digital avatars interacting with each other. New feedback modalities are also introduced in this use case to satisfy new scenarios and requirements in the mobile metaverse. For example, the mobile metaverse is a cyberspace parallel to the real world, which makes the virtual world more real whilst also making the real world richer. The service should better utilize different feedback cues and achieve multi-modal feedback cues to adapt to different scenarios, satisfy the accuracy of a task and user experience, and so on. More modalities should be explored to meet more immersion requirements of the physical entities in the real world such as smell and taste. To realize a more immersive requirement of different scenarios in the mobile metaverse, it is important to explore these temporal in-sync and out-of-sync boundaries for audio, video, haptic, scent, taste, and so on.

Physical devices, physical entities and physical objects exist in physical space, which may be referred to as the real-world. This is in contrast to virtual devices, virtual entities, and virtual objects, which exist in the virtual space of a virtual environment or virtual experience service. There may be a mapping between physical devices, physical entities and physical objects, to virtual devices, virtual entities and virtual objects. The mapping may be one-to-one, many-to-one, or one-to-many. Physical space can be defined as the physical world or real environment comprising, among others, the physical objects and/or devices running software delivering a virtual environment experience service. Hardware that delivers the virtual environment experience service may be distributed geographically and over different software environments. The related hardware may be located physically close to where the physical users of the virtual environment experience service are physically located.

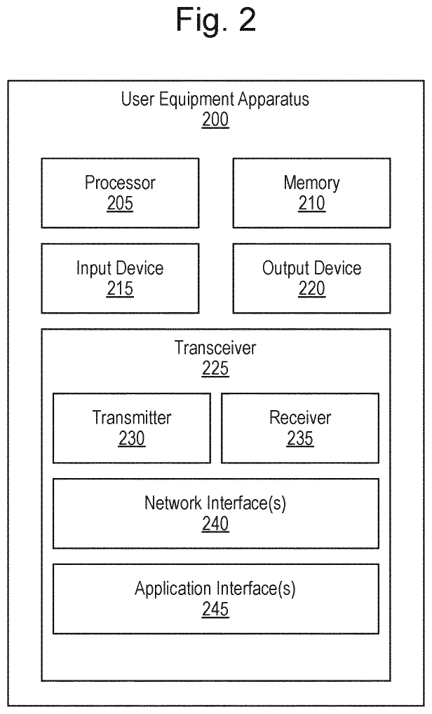

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with the user equipment 102 of FIG. 1, and as such the reference numeral 200 is also used hereinafter to include a user equipment apparatus in accordance with the 102. The user equipment apparatus 200 may also be in accordance with XR enabled devices 710, 810 and 910 of FIGS. 7-9 respectively. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

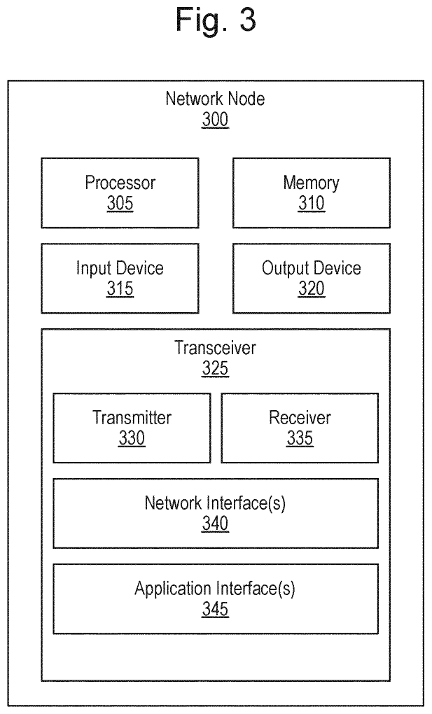

FIG. 3 depicts further details of the network node 300 that may be used for implementing the methods described herein. The network node 300 may be one implementation of an entity in the wireless communications network, e.g. in one or more of the wireless communications networks described herein. The network node 300 may comprise, for example, a network function configured to support a virtual environment experience service. Such network functions include dedicated network functions for user profiles, such as user subscription profile functions (USPF) 732, 870, 970 of FIGS. 7-9 respectively. Alternatively the network function may be a function of a data repository such as unified data management (UDM) or unified data repository (UDR), part of a given user's IMS subscription such as the home subscriber server (HSS), part of the policy control function (PCF), or part of the operation administration and maintenance (OAM) function.

The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound.

For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

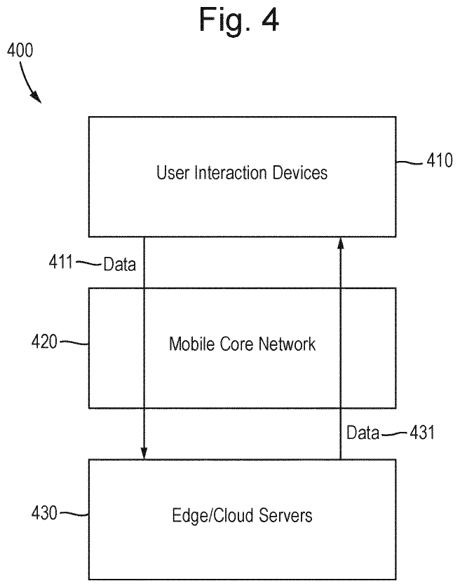

FIG. 4 illustrates an embodiment of a multi-modal feedback service 400 implemented in a wireless communication network. User device interactions 410 are captured as sensor data 411 through the use of sensors including but not limited to VR headsets, XR glasses or other UE devices. Such devices may be in accordance with units 102 and equipment 200 of FIGS. 1-2 respectively. The sensor data 411 is communicated over a 5G mobile network 420 to edge/cloud servers 430. The edge servers 430 may perform coding and rendering and host a multi-modal feedback service. Service/feedback data 431 is provided from the one or more edge servers 430 to user devices 410 such as a display in user equipment to supplement the immersive user interaction experience. The edge servers 430 may also share data with a cloud server. Sensors and user equipment used for user interactions are arranged to run an application for allowing a user to interact with the metaverse. During the application running period, physical entities may achieve an immersive experience with their avatars, and the multi-modal feedback data 431 may be exchanged with each other, whether the physical entities are in proximity or non-proximity. FIG. 4 illustrates generally how a multi-modal feedback service can be applied in the mobile metaverse, and the major impact on 3GPP is whether and how 5GS can be used to better utilize different feedback cues and achieve multi-modal feedback cues concerning the experiences of the multi-physical entities.

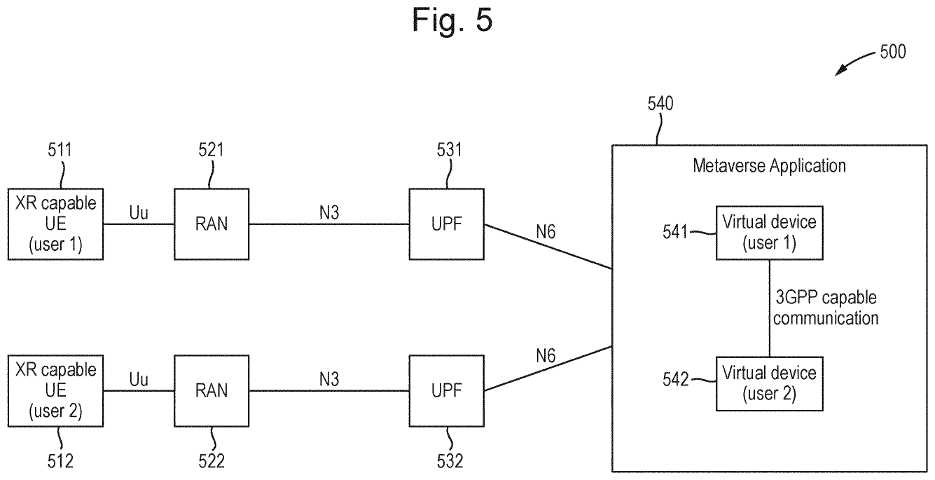

FIG. 5 provides an illustration 500 of interfaces between virtual devices in a metaverse environment and physical devices in the physical world. XR capable user equipment (UE) of first 511 and second 512 users interface with a radio access network (RAN) 521, 522. The RAN 521, 522 itself interfaces with a user plane function (UPF) 531, 532 which itself provides the interface to a data network within which a multiverse application 540 operates. Within the multiverse application 540, virtual devices of first 541 and second 542 users exist. The virtual devices 541 and 542 within the multiverse are capable of 3GPP communications by virtue of the herein described interfaces with the physical wireless radio network. By way of example, options for supporting the communication of users using the multimedia capabilities of the 3GPP network include a user equipment itself supporting connectivity to a 3GPP system (i.e. have a 3GPP modem) or only supporting non-3GPP connectivity (e.g. WLAN connectivity). These devices establish a multimedia session via the 3GPP network using subscription credentials of the 3GPP network. This may be achieved through an IP multimedia sub-system (IMS) session for voice and video communication. By way of further example, communication of users can be achieved via the user's virtual devices used in a metaverse environment as shown in FIG. 5. Each user may own a virtual device, which may be a virtual phone or laptop, with communication between virtual devices being carried out using the 3GPP mobile core network operator voice/media capabilities.

The scenario of facilitating communication between virtual devices using mobile core network credentials and voice/media communication capabilities will now be described in greater detail. In particular, the association by a mobile core network of a virtual device in a virtual environment (such as the metaverse) with a 3GPP user subscription will be presented, in addition to how a virtual device owned by a user in a virtual environment application initiates a communication with a second virtual device owned by a different user.

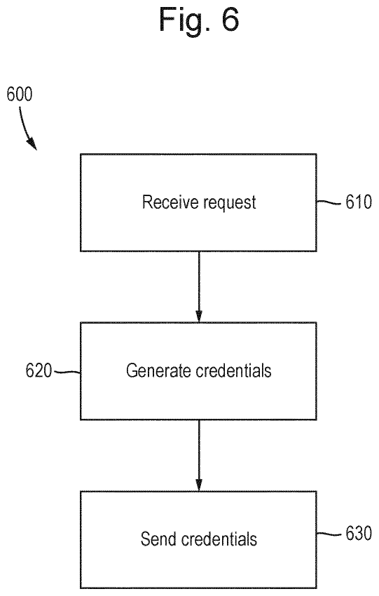

FIG. 6 provides an illustration of an embodiment of a method 600 in a network entity of a wireless communication network. In a first step 610, a request from a first network entity and/or a first user equipment is received. The request being to associate a virtual device with a user subscription of a mobile core network. In a second step 620, credentials are generated for the virtual device for use in establishing media sessions using the mobile core network. In a third step 630, the credentials are sent to the first network entity and/or the first user equipment. Hence a virtual device can be linked to an existing user subscription of a mobile core network, allowing a user of the virtual device to make or receive calls to another virtual device in a virtual environment through use of the mobile core network operator's media capabilities.

The first network entity may be a network function. The first network entity may be selected from the group of network entities consisting of an application function and a network exposure function.

The step of generating credentials 620 may comprise creating or updating a user profile of the user subscription and generating credentials associated with the created or updated user profile. The user profile may comprise at least one of a physical device identifier, a characteristic of the virtual device, a proof of ownership of the virtual device.

The method 600 may further comprise authorizing the request from the first network entity and/or first user equipment by determining ownership of the virtual device. Determining ownership of the virtual device may comprise accessing a non-fungible token associated with the virtual device.

The step of generating credentials 620 may comprise generating a public-user identity in a multimedia subsystem network that is associated with the virtual device.

The method 600 may be for associating a virtual device in a metaverse environment with a user subscription of a core mobile network.

The method 600 may be performed by a user subscription profile function.

The user subscription of the mobile core network may be a user subscription of a 3GPP mobile core network.

The first user equipment may comprise a user profile client.

FIG. 7 provides an illustration of an embodiment of a system 700 implementing the methods described herein. The system 700 comprises a plurality of remote units 710 (which may be remote units 102, user equipment apparatus 200, XR devices 810 or 910), a radio access network 720, a 3GPP mobile core network 730, an edge data network 740 and their respective interactions and interfaces. The figure provides merely an illustration of a system 700, and various other embodiments of similar systems comprising some or all of the entities of FIG. 7 may alternatively be deployed.

The remote units 710 comprise physical devices existing in physical space, such as XR enabled devices, VR headsets, mobile phones, and cellular phones, for instance.

The remote units 710 have stored thereon a metaverse application client 711 that is the application on the user equipment that runs the mobile metaverse service. The remote units 710 further comprise a session initiation protocol (SIP) client 712 for controlling multimedia sessions in an IMS.

The radio access network 720 comprises a plurality of base station units 721 which may be base units 104.

The mobile core network 730 comprises an IMS core 731 and a network entity which may be a logical network function storing a user subscription profile 732. The network entity may be a user subscription profile function (USPF), a function of a data repository such as unified data management (UDM) or unified data repository (UDR), part of a given user's IMS subscription such as the home subscriber server (HSS), part of the policy control function (PCF), or part of the operation administration and maintenance (OAM) function.

The edge data network 740 comprises a metaverse aware application function 741 able to request user profile creations at the 3GPP mobile core network 730. The edge data network 740 also comprises a metaverse virtual environment 742 that includes the metaverse world created, without user avatars, networked virtual devices or dynamic objects. In such an environment 742, the visualization of objects can be possible through rendering to recreate avatars and links between avatars. The edge data network 740 is shown comprising a metaverse server 743 which is the processing entity where the metaverse service runs. Such a server 743 may be edge deployed, but may alternatively be a centralized server such as a cloud server, or may be deployed as a federated server across multiple edge networks and clouds. The metaverse server 743 is deployed by the metaverse service provider. Such a server 743 can provide gaming metaverse services, social network services, vertical services, etc.

Also shown, as an external database from the edge data network 740, is a metaverse database 750. Interaction with this database 750 may be through blockchain or other distributed ledger technology (DLT) network. Within the database 750 there may be different metaverse profiles or object types. These may include profiles, objects, or non-fungible tokens (NFT) owned by an end user, such as those uploaded to the database 750 from a metaverse user (which can be the platform where, for instance, NFT transactions happen or a data storage entity at the service provider domain). These may also include profiles, objects, NFTs owned by the metaverse service provider pre-configured in the database 750 by the service provider. These might include environment objects to be used in a metaverse world such as a table, a bot, or some parameters which can change in real time such as weather changes to be shown in the virtual metaverse world. The database 750 may also include NFT's owned by the mobile network operator. This is the case when communication and computational resources are digitized and provided as a means of interaction between virtual objects. For example, a communication link between two avatars or a slice to be used for communication between physical and virtual devices, can be provided as an NFT by the mobile network operator. Hence, the metaverse service provider may buy this service for the metaverse world service, by interacting with the database 750. This allows the metaverse service provider to automatically reserve dedicated slice/resources for communications using the blockchain network (no mediator).

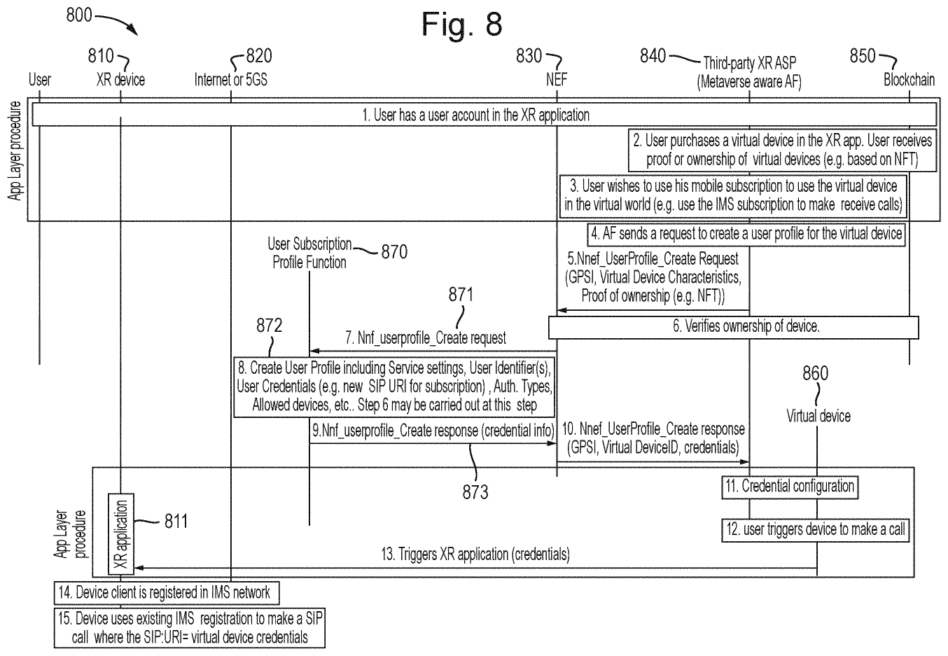

FIG. 8 illustrates a procedure 800 for establishing media communication between virtual devices in a metaverse environment, by associating a virtual device with a user subscription of a 3GPP mobile core network. A system is illustrated comprising an XR device 810, a 5GS core mobile network 820, a network exposure function (NEF) 830, a metaverse aware application function 840, blockchain 850, a virtual device 860, and a user subscription profile function 870. The XR device 810 hosts an XR application 811 and a SIP client registered in IMS of the core mobile network 820 using a user's 3GPP subscription. A user can use the XR application 811 to access a metaverse environment through a metaverse subscription account. This access is provided via the 5GS core network 820. The XR device 810 may support 3GPP connectivity and also may support a media communication protocol (such as through a SIP client with IMS subscription). A user can then acquire a virtual device 860 in the metaverse environment where the virtual device 860 is able to support media communications (for instance a virtual smartphone may be acquired). The user may then desire to use their user subscription of a mobile core network to make and receive media communication calls in the virtual device 860. Such a request can be triggered by the user through the XR application 811 in the metaverse environment. Following the initiation of such a request, the methods in a network entity herein described are followed. This embodiment provides a mechanism for an application function 840 to request to link a virtual device 860 to a user subscription.

The method comprises receipt 871 at the user subscription profile function 870 of a request to associate the virtual device 860 with a user subscription of the mobile core network 820. The request originates from the metaverse aware application function 840, which has been authorized by the network exposure function 830. The request may be sent by the application function 840 using a service based interface procedure to request the creation or updating of a user profile of the user subscription. The request may include an identifier of the user's physical device 810 (for instance a general public subscription identifier (GPSI)), characteristics of the virtual device 860, and proof of ownership (for instance NFT token). In authorizing the request, the NEF 830 may check proof of ownership of the virtual device 860 by validating an associated NFT token in blockchain 850. The user subscription profile function 870 is a dedicated network function for user profiles, however an alternative network function may be equivalently used such as a function of a UDM/UDR, part of a user's IMS subscription such as HSS, part of the PCF or OAM functions, or a function of the IMS core network (for instance the serving call session control function (S-CSCF) or IMS application server).

The method continues 872 with the user subscription profile function 870 updating the user profile of the subscriber to the mobile core network 820 and creating new credentials for the virtual device 860 for use by the virtual device when requesting a media session. If the media capabilities of the mobile core network 820 support IMS then the credentials may be a new public user identity (e.g. a new SIP URI). At this step 872 the user subscription profile function 870 may also validate ownership of the virtual device 860, utilizing blockchain 850.

The method continues 873 with the user subscription profile function 870 sending credentials to the NEF 830 which are forwarded onwards to the metaverse aware application function 840. The credentials may include a public user identity and private user identity of the user's subscription to the mobile core network 820.

For a user to proceed with establishing a media session between virtual devices in a metaverse environment, the user configures their virtual device 860 with the credentials provided by the user subscription profile function 870. The user may then trigger the virtual device 860 to establish a media session (for instance a voice call) using the media capabilities of the mobile core network 820 (for instance, using IMS). The media session can be established to a virtual device of another user, or to a physical device of another user. The virtual device 860 includes credentials to be used for establishing the media session, and also includes a target identifier of the terminating device (for instance a SIP URI of a virtual or physical device). A SIP client of the XR device 810 can therefore be triggered to establish a media session using the credentials and target identifier of the terminating device.

A SIP client of the XR device 810 maintains the connection to the IMS of the mobile core network 820 in order to receive/send media calls, where the virtual device 860 is identified by a public user identity in the IMS. For a terminating call targeted to the virtual device 860, a SIP request will be received by the SIP client in the XR device 810. The XR device 810, based on the public user identity, will notify the XR application client 811 of the SIP terminating call which in turn the XR application client 811 will notify the virtual device 860.

The virtual device 860 in the metaverse environment may itself support a SIP client that is able to perform registration to IMS of a core mobile network 820 using a user's 3GPP subscription and is further able to establish a media session using credentials of the virtual device 860 and a target identifier of a terminating device. In such a case, the virtual device 860 will initiate registration to an IMS using a public user identity and private user identity of a user's subscription to a core mobile network. As such, including credentials and target identifier of a terminating device into the virtual device 860 may not be needed.

Alternatively, the virtual device 860 may support an application client that itself may discover a SIP proxy and initiate IMS registration using the provisioned credentials via the SIP proxy.

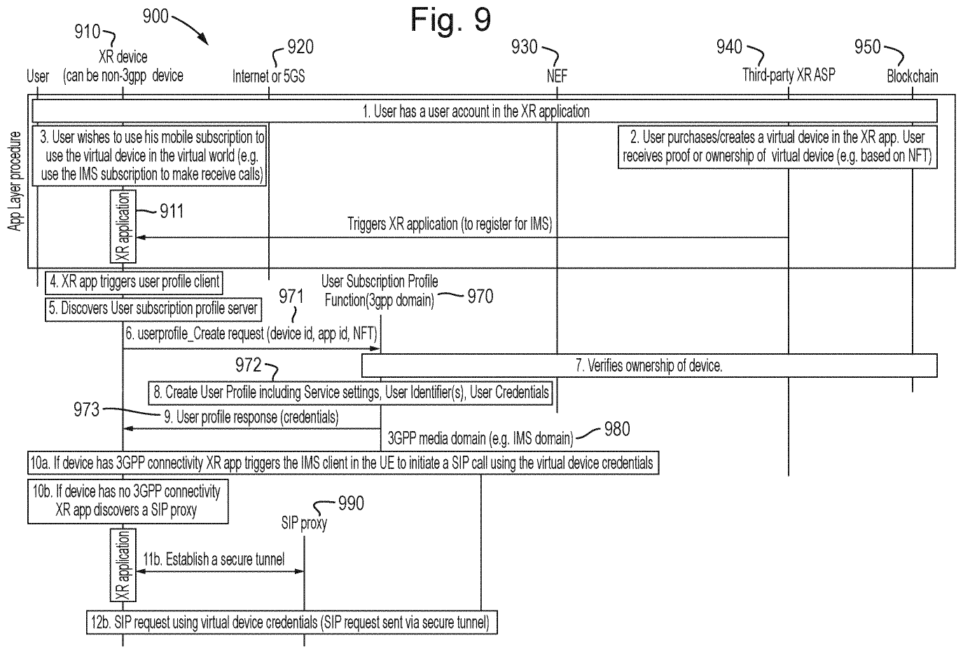

FIG. 9 illustrates a further procedure 900 for establishing media communication using virtual devices in a metaverse environment where a virtual device or XR application supports a media client (such as an IMS client), by associating a virtual device with a user subscription of a 3GPP mobile core network.

A system 900 is illustrated comprising an XR device 910, a 5GS core mobile network 920, a network exposure function (NEF) 930, a metaverse aware application function 940, blockchain 950, a user subscription profile function 970, a 3GPP media domain 980, and a SIP proxy 990. The XR device 910 hosts an XR application 911 with user a profile client.

A user can use the XR application 911 to access a metaverse environment through a metaverse subscription account. This access is provided via the 5GS core network 920. The XR device 910 may support 3GPP connectivity and also may support a media communication protocol (such as through a SIP client with IMS subscription). A user can then acquire a virtual device in the metaverse environment where the virtual device is able to support media communications (for instance a virtual smartphone may be acquired). The user may then desire to use their user subscription of a mobile core network to make and receive media communication calls in the virtual device. Such a request can be triggered by the user through the XR application 911 in the metaverse environment. The XR application 911 triggers a user profile client to create a user profile. The XR application 911 discovers a user subscription profile server (for instance using a DNS query). A request to create a user profile for the user's subscription is then sent from the XR application 911. Following the initiation of such a request, the methods in a network entity herein described are followed. This embodiment provides a mechanism for the configuration of a virtual device from an application 911 in a user equipment (such as an XR device 910).

The method comprises receipt 971 at the user subscription profile function 970 of a request to create a user profile for the user's subscription. The request may include an identifier of the user's physical device (for instance GPSI), the characteristics of the virtual device, and proof of ownership (for instance an NFT token). The user subscription profile function 970 may validate ownership of the virtual device towards blockchain 950.

The user subscription profile function 970, in a subsequent step 972, creates or updates the user profile of the subscriber linking the virtual device to the subscription and creating new credentials for the virtual device for use by the virtual device when requesting a media session. If the media capabilities of the mobile core network 920 support IMS then the credentials may be a new public user identity (such as a new SIP-URI).

The user subscription profile function 970, in a subsequent step 973, sends a response including the credential of the virtual device. The credentials may include public user identity and private user identity of the user's subscription.

In embodiments where 3GPP connectivity is supported, a user can then trigger the XR application 911 to trigger a media client in the user equipment (the XR device 910) to initiate a media call (such as using IMS) using the virtual device credentials. If 3GPP connectivity is not supported, then the XR application 911 may discover a proxy 990 that can interface with the operators IMS domain. The XR application 911 then establishes a secure connection with the proxy 990 and sends a request to establish a media session (i.e. a SIP request) to the IMS domain via the secure tunnel.

The XR application 911 maintains connection to the IMS network in order to receive/send media calls where the XR application client 911 is identified by the public user identity in the IMS/media network.

In other embodiments, a virtual device in a metaverse environment may support an application client that itself is able to discover a proxy that can interface to a mobile core network operators IMS domain. Such an application client may then itself establish a secure connection with the proxy and send a request to establish a media session. In such an approach, the XR application 911 does not itself need to support the application client.

The methods described herein can be implemented in a network entity (which may be a network function) comprising a receiver arranged to receive a request from a first network entity and/or a first user equipment to associate a virtual device with a user subscription of a mobile core network; a processor arranged to generate credentials for the virtual device for use in establishing media sessions using the mobile core network; and a transmitter arranged to send the credentials to the first network entity and/or the first user equipment.

In some embodiments, the first network entity may be a network entity selected from the group of network entities consisting of: an application function; a network exposure function.

In some embodiments, the processor may be further arranged to create or update a user profile of the user subscription and generate credentials associated with the created or updated user profile. The user profile may comprise at least one of: a physical device identifier; a characteristic of the virtual device; and a proof of ownership of the virtual device.

In some embodiments, the processor may be further arranged to authorize the request from the first network entity and/or first user equipment by determining ownership of the virtual device. The processor may be further arranged to determine ownership of the virtual device by accessing a non-fungible token associated with the virtual device.

In some embodiments, the credentials generated by the processor may comprise a public-user identity in a multimedia subsystem network that is associated with the virtual device.

The network entity may be for associating a virtual device in a metaverse environment with a user subscription of a mobile core network. The network entity may be a user subscription profile function.

In some embodiments, the user subscription may be a user subscription of a 3GPP mobile core network.

In some embodiments, the first user equipment may comprise a user profile client.

The disclosure herein addresses the scenario to facilitate communication between virtual devices in the metaverse network using mobile core network credentials and voice/media communication capabilities (e.g. IMS). The disclosure takes into account that in the metaverse environment each user may own a number of virtual devices that can support a media communication capability. The user can use the virtual device to make or receive calls using the 3GPP operator's media capabilities to other virtual devices in the metaverse environments. The disclosure proposes methods and network entities (such as network functions) that link a virtual device in a metaverse environment with a 3GPP subscription; and provide credentials for the virtual device to utilize the media capabilities (i.e. IMS network) of an operator to make or receive calls. The disclosure provides a different solution, by way of enabling additional devices to be linked to existing user subscriptions, and with respect to IMS, provides a procedure for dynamic configuration of public user identities to each user's device.

An aspect provides a method for associating a virtual device in a virtual environment with a mobile core network subscription, the method comprising: receiving a request from a first function (for instance a network exposure function or application function) where the request incudes a request to associate a device in the metaverse environment to a 3GPP subscription; optionally authorizing the request by determining ownership of the device (i.e. the device is owned by the user); determining credentials for the device, wherein the credentials are used by the device to establish a media session via the 3GPP domain; sending a response to the first function, wherein the response includes the credentials. The ownership of the device may be determined based on a non-fungible token of the device. The credential of the device may be a public user identity in the IMS network that is associated with the virtual device.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations used herein would be understood by a person skilled in the art:
AF Application function
XR Augmented/mixed reality
NFT Non-fungible token
IMS IP multimedia system
SIP Session initiated protocol
GPSI General public subscription identifier
URI Uniform resource identifier

1. A network entity for wireless communication, comprising:
at least one memory; and
at least one processor coupled with the at least one memory and configured to cause the network entity to:
receive a request from one or more of a first network entity or a user equipment to associate a virtual device with a user subscription of a mobile core network;
generate credentials for the virtual device for use in establishing media sessions using the mobile core network; and
send the credentials to one or more of the first network entity or the user equipment.

2. The network entity of claim 1, wherein the first network entity is at least one of an application function, or a network exposure function.

3. The network entity of claim 1, wherein the at least one processor is configured to cause the network entity to create or update a user profile of the user subscription and generate the credentials associated with the user profile.

4. The network entity of claim 3, wherein the user profile comprises at least one of a physical device identifier, a characteristic of the virtual device, or a proof of ownership of the virtual device.

5. The network entity of claim 1, wherein the at least one processor is configured to cause the network entity to authorize the request from one or more of the first network entity or the user equipment by determining ownership of the virtual device.

6. The network entity of claim 5, wherein the at least one processor is configured to cause the network entity to determine the ownership of the virtual device by accessing a non-fungible token associated with the virtual device.

7. The network entity of claim 1, wherein the credentials comprise a public-user identity in a multimedia subsystem network that is associated with the virtual device.

8. The network entity of claim 1, wherein the at least one processor is configured to cause the network entity to associate the virtual device in a metaverse environment with the user subscription of the mobile core network.

9. The network entity of claim 1, wherein the network entity is a user subscription profile function and the user subscription is a user subscription of a 3GPP mobile core network.

10-11. (canceled)

12. A method performed by a network entity, the method comprising:
receiving a request from one or more of a first network entity or a user equipment to associate a virtual device with a user subscription of a mobile core network;
generating credentials for the virtual device for use in establishing media sessions using the mobile core network; and
sending the credentials to one or more of the first network entity or the user equipment.

13-22. (canceled)

23. A processor for wireless communication, comprising:
at least one controller coupled with at least one memory and configured to cause the processor to:
receive a request from one or more of a network entity or a user equipment to associate a virtual device with a user subscription of a mobile core network;
generate credentials for the virtual device for use in establishing media sessions using the mobile core network; and
send the credentials to one or more of the network entity or the user equipment.

24. The processor of claim 23, wherein the network entity is at least one of an application function, or a network exposure function.

25. The processor of claim 23, wherein the at least one controller is configured to cause the processor to create or update a user profile of the user subscription and generate the credentials associated with the user profile.

26. The processor of claim 25, wherein the user profile comprises at least one of a physical device identifier, a characteristic of the virtual device, or a proof of ownership of the virtual device.

27. The processor of claim 23, wherein the at least one controller is configured to cause the processor to authorize the request from one or more of the network entity or the user equipment by determining ownership of the virtual device.

28. The processor of claim 27, wherein the at least one controller is configured to cause the processor to determine the ownership of the virtual device by accessing a non-fungible token associated with the virtual device.

29. The processor of claim 23, wherein the credentials comprise a public-user identity in a multimedia subsystem network that is associated with the virtual device.

30. The processor of claim 23, wherein the at least one controller is configured to cause the processor to associate the virtual device in a metaverse environment with the user subscription of the mobile core network.

31. The processor of claim 23, wherein the network entity is a user subscription profile function and the user subscription is a user subscription of a 3GPP mobile core network.

32. A user equipment for wireless communication, comprising:
at least one memory; and
at least one processor coupled with the at least one memory and configured to cause the user equipment to:
transmit a request to associate a virtual device with a user subscription of a mobile core network that generates credentials for the virtual device for use in establishing media sessions using the mobile core network; and
receive the credentials.
